(19) United States
(12) Patent Application Publication
(10) Pub. No.: US 2011/0218787 A1
(43) Pub. Date: Sep. 8, 2011

(54) Computational Earthquake

(75) Inventor: Ching-Min Huang, Tainan City (TW)

(73) Assignee: Ching-Min Huang, Tainan City (TW)

(21) Appl. No.: 13/047,179

(22) Filed: Mar. 14, 2011

(51) Int. Cl. G06G 7/48

(52) U.S. Cl. 703/5

(57) ABSTRACT

Computational Earthquake is a new earthquake forecasting method.

### BRIEF SUMMARY

Computational Earthquake is a new earthquake forecasting method.

### BACKGROUND

The moon is a satellite of the earth and travels around it in orbit. Since the earth is a globe and rotates continuously, ocean blocks at different distances to the moon are subject to different gravitational pulls of the moon, causing the tidal phenomena. Earthquakes can be forecast by observing heavenly bodies that run in periodic patterns, which accounts for the periodic return of major earthquakes. The existing theories on earthquakes fail to provide an effective forecast because earthquakes do not result from the internal factors of the earth, but rather from the margin of gravity produced by the motion of heavenly bodies.

### DETAILED DESCRIPTION

A 3D stereogram of the tectonic plate fault can be drawn on the basis of existing earthquake energy observations, earthquake epicenter and depth of the seismic focus, together with the relationship of the marginal gravitational forces caused by the motion of the earth and heavenly bodies. This can not only create an empirical equation for earthquake forecasting, but also simulate the earthquake energy, earthquake epicenter and depth of seismic focus in the case of the prospective motion of heavenly bodies. The national disaster prevention agency should establish an earthquake forecast center and carry out analyses according to the latest simulation results in order to determine whether there will be an earthquake. It should make forecasts in a way that is similar to weather forecasting, but based on the possible position of the epicenter, the possible depth of the seismic focus, the size of energy generated from plates sliding, the earthquake intensity across the country, etc. Based on the established simulated earthquake model, earthquakes over the coming centuries can be calculated and deduced with the use of super computers to accurately estimate the occurrence probability of earthquakes (in the earthquake regression period of 475 years) that will exceed the designed earthquake-resistance level of the buildings during their 50-year designed service life. Specification formulation for the structural design of earthquake resistance in civil engineering can be based on the accurate estimation of the earthquake intensity across the country, and its maximum surface acceleration via the earthquake model. Since the motion of the heavenly bodies has an influence on the exceedance probability, the exceedance probability is constant in the short term; however, the exceedance probability is not constant in the long term. Hence, continuous calculations are necessary to update the probabilistic data, and estimate the required earthquake resistance across the country in accordance with the structural reliability theory. Along with the calculation of earthquake simulation results, the government needs to formulate a uniform earthquake simulation input and output format, as well as provide a three-dimensional image browser for the earthquake simulation results to enable those concerned with the latest earthquake simulation results to download the relevant simulation data at any time for browsing, studying and analyzing.

1. The said earthquakes do not result from the release of energy accumulated in the Earth's crust; on the contrary, the gravity from the motion of heavenly bodies is causing the sliding of tectonic plates, and the product of the slide force and the slide distance comprises the energy released by earthquakes. Like the relation between the static friction coefficient and the kinetic friction coefficient in physics, to make the tectonic plate slide, the margin of gravity must exceed the static friction. Once the sliding begins, the static friction between the tectonic plates will turn into kinetic friction. Sliding a certain distance inevitably allows its kinetic friction to become effective, stopping the sliding; at this point, the seismic activity will cease. Earthquakes in other non-junction areas cannot exert direct influences on the junction area because the earthquake zone is confined by the annular section formed by the junction between the tectonic plates. In other words, the gravity pull on the tectonic plates from heavenly bodies is a local, not universal, phenomenon. The local scope of tectonic plates depends on the earthquake forecast model, which is appropriate as long as it conforms to the explanation of the earthquake forecast model.

2. The said earthquake energy observation, earthquake epicenter, depth of seismic focus, and the correlations among the motions of heavenly bodies and earth should be based on the earthquake observation data around the world, namely astrophysical observation data, in order to establish the relationship between the earthquake energy and the gravity of heavenly bodies. For the calculation of the gravity of heavenly bodies, the equation of Newton's law of gravity is adopted. It can be converted into:
$${g}_{h} = \frac{{GM}_{h}}{{R}^{2}} ,$$
where gₕ is the gravity caused by heavenly bodies; G is the gravity constant; Mₕ is the mass of the heavenly body; and R is distance between the heavenly body and the point on the earth. Given that the gravity of heavenly bodies and that of the earth and its centrifugal force are not collinear, it is necessary to take the intersection angle θ into consideration to compensate for the influence of gₕ in the earth's gravitational direction with the trigonometric function. Under the consideration of the earth latitude and oblateness, the resultant direction of the gravity of the earth and its rotational centrifugal force can be used to calculate the deflection θ caused by the centrifugal force, which can be used as the basis for correcting the direction of the gravitational force of the heavenly bodies.

3. The stated 3D stereogram of the tectonic plate fault is produced in such a way that the earthquake fault line and its bandwidth range are first defined with a 2D plane map; then, based on the earthquake epicenter, depth and energy, the depth of the sliding surface is estimated, and lastly, the relevant and adjacent point locations of earthquake focus are drawn into a 3D stereogram. The 3D stereogram of the tectonic plate fault is then created on the computer. Through simulating the influence of gravity on the tectonic plates, which is exerted on each area of the world by the orbit of the heavenly bodies, the interaction force between the tectonic plates caused by the margin gravity is calculated. Based on the past seismic data, the static friction necessary for tectonic plate sliding is estimated in correspondence to the margin of gravity caused by the motion of heavenly bodies, in order to predict whether or not the tectonic plate will slide. The estimation of the static and kinetic friction coefficients of the tectonic plate can be obtained through geological drilling or by obtaining the same soil type to measure its friction coefficient through experiments, to serve as the basic physical property of the 3D stereogram of the tectonic plate fault. The normal gravity of the 3D stereogram of the tectonic plate fault in each area of the world will be based on the data defined through the measurement of the physical observation instrument according to WGS84 or relevant international organization.
